(19) United States
(12) Patent Application Publication
(10) Pub. No.: US 2010/0257959 A1
(43) Pub. Date: Oct. 14, 2010

(54) DOUBLE CLUTCH TRANSMISSION

(75) Inventors: Wolfgang RIEGER, Friedrichshafen (DE); Matthias REISCH, Ravensburg (DE); Juergen WAFZIG, Eriskirch (DE); Philip RECKER, Friedrichshafen (DE); Gerhard GUMPOLTSBERGER, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/758,990

(22) Filed: Apr. 13, 2010

(30) Foreign Application Priority Data
Apr. 14, 2009 (DE) 10 2009 002 355.0

(51) Int. Cl. F16H 3/093

(52) U.S. Cl. 74/330

(57) ABSTRACT

A double clutch transmission comprising two clutches (K1, K2) the input sides of which are each connected to a drive shaft (w_an) and the output sides of which are respectively connected to one of two coaxially disposed transmission input shafts (w_k1, w_k2). Toothed idler gearwheels (8, 9, 10, 11, 12, 13, 14, 15) are mounted on the two countershafts (w_v1, w_v2) while toothed fixed gearwheels (1, 2, 3, 4) are provided on the two transmission input shafts (w_k1, w_k2) whereby several power shiftable forward gears (1, 2, 3, 4, 5, 6, 7, 8) and at least one reverse gear (R1, R2, R3) are shiftable. A maximum of five gear planes (8-12, 9-13, 10-14, 11-15) are provided so that at least one power shiftable winding path gear (G8, C3) is shifted by the shift element (M) and at least one power shiftable winding path gear (R1) is shifted by the shift element (P).

This application claims priority from German patent application serial no. 10 2009 002 355.0 filed Apr. 14, 2009.

### FIELD OF THE INVENTION

The present invention relates to a double clutch transmission.

### BACKGROUND OF THE INVENTION

A six-speed or seven-speed double clutch transmission is known from the published patent DE 103 05 241 A1. The double clutch transmission comprises two clutches, which in each case are connected on the input sides thereof to the drive shaft and on the output side thereof to one of the two transmission input shafts. The two transmission input shafts are disposed coaxially to one another. Furthermore, two countershafts are disposed axially parallel to the two transmission input shafts, the idler gears of which mesh with fixed gears of the transmission input shafts. In addition, coupling devices are supported in an axially displaceable, rotationally fixed manner on the countershafts in order to be able to shift the respective toothed gearwheels. The transmission ratio selected in each case is transmitted by way of the output gears to a differential. In order to implement the desired transmission ratio steps in the known double clutch transmission, a plurality of gear planes are required, thereby making a significant construction space necessary during installation.

Furthermore, a spur-gear multi-speed transmission is known from the published patent DE 38 22 330 A1. The spur-gear multi-speed transmission comprises a power shiftable double clutch, one part of which is connected to a drive shaft and the other part of which is connected to a hollow drive shaft rotatably mounted on the drive shaft. For certain transmission ratios, the drive shaft can be coupled to the hollow drive shaft by way of a shift element.

A power-shift transmission having two clutches, each being associated with a subtransmission, is known from the published patent DE 10 2004 001 961 A1. The transmission input shafts of the two subtransmissions are disposed coaxially to one another and mesh with idler gears of the associated countershafts by way of fixed gears. The respective idler gears of the countershafts can be connected in a rotationally fixed manner to the respective countershaft by means of associated shift elements. From this published patent, an eight-speed transmission is known, in which a further shift element is provided for coupling the two transmission input shafts so as to implement a further transmission ratio step. In this embodiment, the seven-speed transmission already requires at least six gear planes in the two subtransmissions to implement the transmission ratio steps. This undesirably increases the length in the axial direction, thereby considerably limiting the installation possibility in a vehicle.

Furthermore, another power-shift transmission comprising two input shafts and only one countershaft is known from the published patent DE 10 2005 028 532 A1. An eight-speed transmission in this embodiment, for example, requires more than seven gear planes in order to be able to implement the transmission ratio steps, in particular the reverse gear transmission ratios. This undesirably increases the length in the axial direction.

### SUMMARY OF THE INVENTION

The object of the present invention is to propose a double clutch transmission of the type described above, in which several power shiftable transmission ratio steps can be implemented in the most cost-effective manner and with the least components possible, while requiring little construction space.

A construction space-optimized double clutch transmission having two clutches is therefore proposed, the input sides of which are connected to a drive shaft and the output sides of which are each connected to one of two transmission input shafts disposed coaxially to one another. The double clutch transmission comprises at least two countershafts or the like, on which toothed gearwheels designed as idler gears are rotatably mounted, wherein on the two transmission input shafts, rotationally fixed toothed gearwheels designed as fixed gears are provided, at least some of which mesh with the idler gears. Furthermore, a plurality of coupling devices are provided for connecting idler gears to a countershaft in a rotationally fixed manner. The double clutch transmission according to the invention comprises an output gear or constant pinion which is provided on each of the countershafts and which is coupled to a gearing of a drive shaft in order to connect the respective countershaft to the output drive, and it further comprises at least one shift element for connecting two toothed gearwheels in a rotationally fixed manner, wherein several power shiftable gears can be implemented.

According to the invention, the proposed double clutch transmission preferably comprises a maximum of five gear planes, by which at least eight power shiftable gears are implemented with a low construction space requirement. For example, one of the ways in which the maximum of five, preferably four or five, gear planes can be formed is by at least three dual gear planes, wherein in each dual gear plane an idler gear of each of the first and second countershafts is associated with a fixed gear of one of the transmission input shafts, and wherein at least in one of the dual gear planes an at least one idler gear can be used for at least two gears, so that at least one winding path gear can be shifted by an activated winding path gear shift element, which is associated with the first countershaft or the second countershaft.

For example, the four gear planes can be formed exclusively as dual gear planes. It is also conceivable to use at least one single gear plane, in addition to the dual gear planes, wherein in each single gear plane an idler gear of the countershafts is associated with a fixed gear of one of the transmission input shafts. Other configurations are also possible.

Due to the possible multiple uses of idler gears, in the proposed double clutch transmission it is possible to implement a maximum number of transmission ratios with the least gear planes possible, wherein preferably the first eight forward gears can be power shifted with sequential execution.

In order to optimize the gradient in the double clutch transmission proposed according to the invention, a dual gear plane can be replaced by two single gear planes, for example, in that a fixed gear is replaced by two fixed gears. In this way, particularly smooth, progressive gear stepping can be achieved. It is also possible to replace two single gear planes by a dual gear plane.

The proposed double clutch transmission can preferably be implemented as an 8-speed transmission having at least eight power shiftable gear steps. Due to the short design compared to known transmission arrangements, the double clutch transmission according to the invention is particularly suited for a front-transverse design of a vehicle. However, other installations are also conceivable, depending on the type and construction space situation of the vehicle in question in each case.

In the proposed double clutch transmission, the first and/or eighth forward gears can preferably be a winding path gear. In addition, at least one reverse gear and/or other gears, such as crawler gears or overdrive gears, can likewise be designed as winding path gears and implemented in a power shiftable manner. For example, the first power shiftable forward gear or the highest power shiftable gear can be a winding path gear.

In the proposed double clutch transmission, each countershaft can be associated with at least one winding path gear shift element to implement the winding path gears. Optionally, further winding path gear shift elements can be provided, for example in the form of shift elements associated with the first or the second countershaft, or also in the form of winding path gear coupling devices, which are quasi associated as winding path gear shift elements with the constant pinions in order to detach them from the associated countershaft so as to implement further winding path gears. In this way, optionally both constant pinions can be shiftably connected to the associated countershaft.

For example, depending on the embodiment, three to five shiftable idler gears can be associated with the first countershaft and the second countershaft, wherein the idler gears in each case mesh with fixed gears of the associated transmission input shafts.

If the highest, or second to the highest, gear increment is designed to be higher than the one respectively lower than that, a particularly high output torque or drive power can be provided during a downshift depending on the driver's wish.

Advantageously, in the double clutch transmission according to the invention four or five shifting points are required on the first countershaft and only four shifting points on the second countershaft. However, in total a maximum of nine shifting points on both countershafts together may be sufficient to implement the proposed gear steps. Further shifting points, however, are possible.

According to the invention, it is possible to connect the idler gear of the second subtransmission to the idler gear of the first subtransmission by way of the at least one additional shift element on the first and/or second countershafts, thereby allowing the shift element to shift at least one winding path gear.

With the double clutch transmission according to the invention, when the shift element is activated and, if necessary, additionally the coupling devices are disengaged, in this way at the output gears winding path gears can be implemented in which the toothed gearwheels of both subtransmissions are coupled to one another in order to thereby achieve a flow of power through both subtransmissions. The respective winding path gear shift element is used to couple two idler gears, thereby making the transmission input shafts dependent on one another.

In the double clutch transmission, the arrangement of the shift elements for coupling two defined idler gears can be varied, so that the shift elements do not necessarily have to be disposed between the idler gears to be coupled. Accordingly, other arrangement positions of the respective shift elements are conceivable, for example in order to optimize the linking to an actuator system.

According to one possible embodiment of the invention, for example, four dual gear planes can be implemented, wherein the fixed gears of the second transmission input shaft of the second subtransmission are associated with a first gear plane and a second gear plane, and wherein the fixed gears of the first transmission input shaft of the first subtransmission are associated with a third gear plane and a fourth gear plane.

Within the context of a further embodiment of the invention, it is also possible to provide three dual gear planes and two single gear planes in the proposed double clutch transmission. The fixed gears of the second transmission input shaft, for example, can be associated with the first gear plane and the second gear plane as dual gear planes, wherein the first subtransmission can then be associated with a third gear plane as a dual gear plane, a fourth gear plane as a single gear plane, and a fifth gear plane as a single gear plane.

In the double clutch transmission according to the invention preferably four dual gear planes and a single gear plane are provided. In this embodiment, for example, the second subtransmission can be associated with a first gear plane as a dual gear plane, a second gear plane as a single gear plane, and a third gear plane as a dual gear plane. For example, the first subtransmission can be associated with a fourth gear plane and a fifth gear plane, each as double gear planes.

In order to provide the necessary reversal of rotation for implementing reverse gears in the double clutch transmission according to the invention at least one intermediate gear can be used, which is disposed on an intermediate shaft. It is also possible that one of the idler gears of a countershaft serves as an intermediate gear for at least one reverse gear. For the reverse gear transmission ratio in this case no additional intermediate shaft is required, since one of the idler gears meshes with both a fixed gear and a further shiftable idler gear of the other countershaft. In this way, the intermediate gear required for the reverse gear is disposed as a shiftable idler gear on a countershaft, and additionally is used to implement at least one further forward gear. The intermediate gear can also be designed as a stepped gear, independent of whether it is disposed on the countershaft or on an additional intermediate shaft. It is also possible that the intermediate gear is not disposed on one of the existing countershafts, but that it is provided, for example, on a further separate shaft, such as a third countershaft.

In order to obtain the desired transmission ratio steps, in the double clutch transmission according to the invention at least one bidirectionally operative coupling device or the like can be disposed on each countershaft. In the activated or engaged state, depending on the actuating direction, the provided coupling devices can connect an associated idler gear in a rotationally fixed manner to the countershaft. In addition, a coupling device operative in one direction may be disposed on at least one of the countershafts. The coupling devices used can be hydraulically, electrically, pneumatically, or mechanically actuated clutches, or also form-locking dog clutches, and any type of synchronizers, which are used to connect an idler gear to a countershaft in a rotationally fixed manner. It is possible to replace a bidirectionally operative coupling device with two coupling devices operative in one direction, or conversely.

It is conceivable to vary the listed arrangement possibilities of the toothed gearwheels and to change the number of the toothed gearwheels and the number of the coupling devices in order to implement additional power shiftable and non-power shiftable gears and achieve construction space as well as component savings in the proposed double clutch transmission. In particular, fixed gears of dual gear planes can be divided into two fixed gears for two single gear planes. In this way, step changes can be improved. In addition, it is possible to exchange the countershafts. The subtransmissions can also be exchanged, which is to say mirrored about a vertical axis. In the process, the hollow shaft and solid shaft are exchanged. In this way it is possible, for example, to dispose the smallest gear wheel on the solid shaft in order to further optimize the use of the available construction space. In addition, adjacent gear planes can be exchanged, for example in order to optimize shaft deflection and/or to optimally link a shift actuating system. In addition, the respective arrangement positions of the coupling devices on the gear plane can be varied. Furthermore, the effective direction of the coupling device can be varied.

The gear numbers used in the present invention were freely defined. It is also possible to add a crawler gear and/or an overdrive gear, for example, in order to improve the off-road handling characteristics or the acceleration behavior of a vehicle. In addition, for example, a first gear can be eliminated, such as to better optimize the step changes as a whole. The gear numbers vary accordingly with these measures.

Independent of the respective variant embodiments of the double clutch transmission, it is also possible to arrange the drive shaft and the output shaft not coaxially to one another, which results in a particularly space-saving arrangement. For example, the shafts thereby disposed spatially behind one another can also be slightly offset from one another. In this arrangement, a direct gear having a transmission ratio of one can be implemented by way of gear meshing and can advantageously be placed relatively freely on the sixth to ninth gears. Other arrangement possibilities of the drive shaft and the output shaft are also conceivable.

The proposed double clutch transmission is preferably equipped with an integrated output stage. The output stage may comprise a fixed gear on the output shaft as the output gear, which meshes with a first output gear as the constant pinion of the first countershaft and with a second output gear as the constant pinion of the second countershaft. Optionally, both output gears can be designed as shiftable gears. In order to shift the respective output gear, for example, a winding path gear coupling device may be associated, which in the disengaged state releases the connection between the associated countershaft and the output gear in order to be able to shift winding path gears.

Advantageously, the lower forward gears and the reverse gears can be actuated by a start-up or shifting clutch in order to focus higher loads on this clutch and thereby be able to implement the second clutch in a more space-saving and cost-effective manner. In particular, the gear planes can be disposed in the proposed double clutch transmission such that starting can be carried both out by way of the inner transmission input shaft or the outer transmission input shaft, and therefore by way of the clutch that is better suited, which is also possible for a concentrically disposed, radially nested construction of the double clutch. For this purpose, the gear planes can be disposed and/or exchanged accordingly mirror-symmetrically.

Independent of the respective variant embodiment, the provided gear planes can, for example, be exchanged in the double clutch transmission.

### BRIEF DESCRIPTION OF THE DRAWINGS

The present invention will be explained in more detail hereinafter with reference to the figures, wherein:

FIG. 1 is a schematic illustration of a 1st variant embodiment of an eight-speed double clutch transmission according to the invention;

FIG. 2 is a shift pattern of the 1st variant embodiment according to FIG. 1;

FIG. 3 is a schematic illustration of a 2nd variant embodiment of the eight-speed double clutch transmission according to the invention;

FIG. 4 is a shift pattern of the 2nd variant embodiment according to FIG. 3;

FIG. 5 is a schematic illustration of a 3rd variant embodiment of the eight-speed double clutch transmission according to the invention;

FIG. 6 is a shift pattern of the 3rd variant embodiment according to FIG. 5;

FIG. 7 is a schematic illustration of a 4th variant embodiment of the eight-speed double clutch transmission according to the invention;

FIG. 8 is a shift pattern of the 4th variant embodiment according to FIG. 7;

FIG. 9 is a schematic illustration of a 5th variant embodiment of the eight-speed double clutch transmission according to the invention;

FIG. 10 is a shift pattern of the 5th variant embodiment according to FIG. 9;

FIG. 11 is a schematic illustration of a 6th variant embodiment of the eight-speed double clutch transmission according to the invention; and

FIG. 12 is a shift pattern of the 6th variant embodiment according to FIG. 11.

### DETAILED DESCRIPTION OF THE PREFERRED EMBODIMENTS

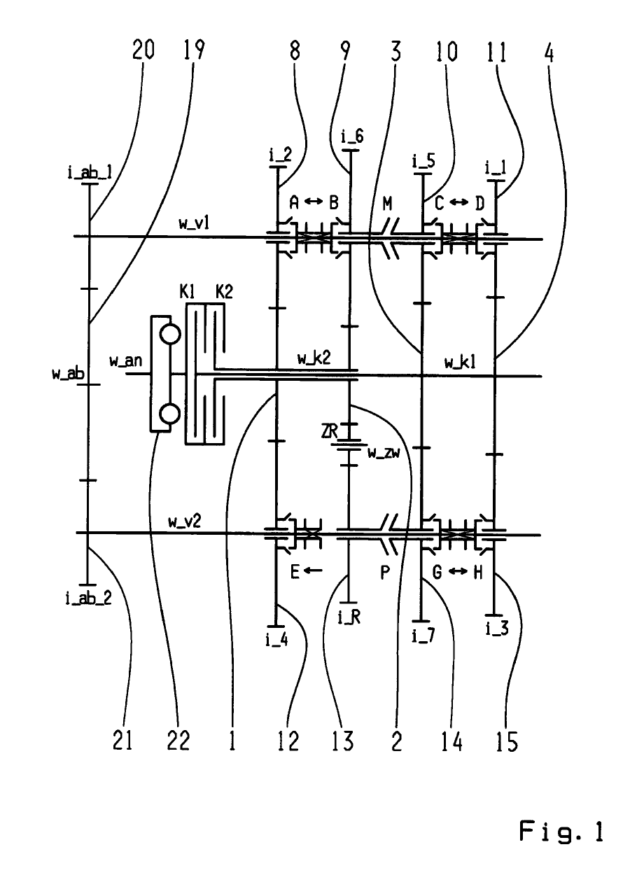

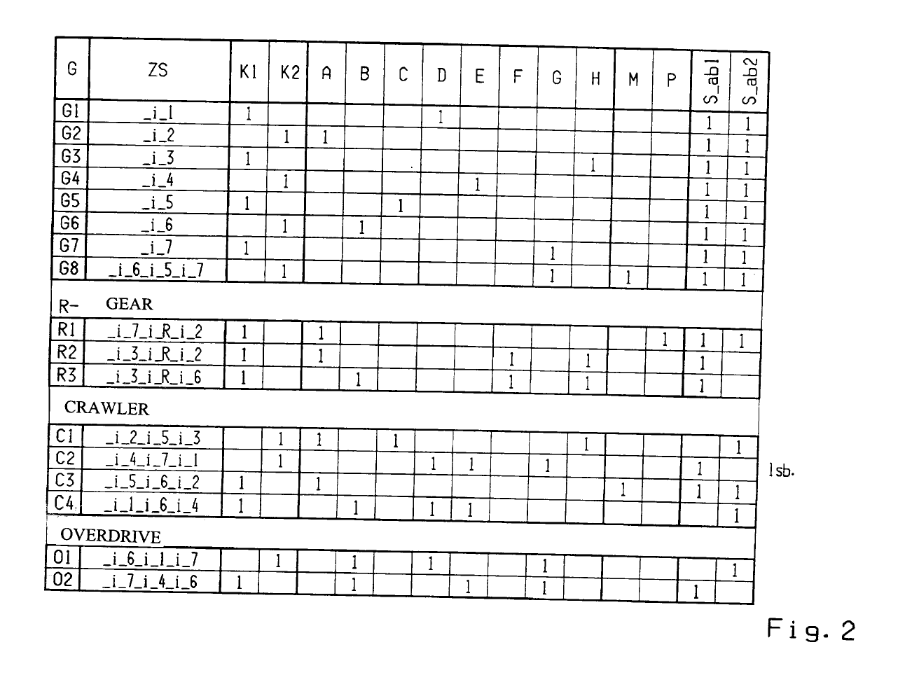

FIGS. 1, 3, 5, 7, 9, and 11 each show a possible variant embodiment of an eight-speed double clutch transmission. The corresponding shift patterns for the different variant embodiments are illustrated in tabular form in FIGS. 2, 4, 6, 8, 10, and 12.

The eight-speed double clutch transmission comprises two clutches K1, K2, the input sides of which are connected to a drive shaft w_an and the output side of each is connected to one of two transmission input shafts w_k1, w_k2, which are disposed coaxially to one another. In addition, a torsion vibration damper 22 can be disposed on the drive shaft w_an. Furthermore, two countershafts w_v1, w_v2 are provided, on which toothed gearwheels designed as idler gears 7, 8, 9, 10, 11, 12, 13, 14, 15, 16, 17 are rotatably mounted. The two transmission input shafts w_k1, w_k2 are provided with toothed gearwheels, which are disposed in a rotationally fixed manner and designed as fixed gears 1, 2, 3, 4, 5, and at least some of which mesh with the idler gears 7, 8, 9, 10, 11, 12, 13, 14, 15, 16, 17.

In order to be able to connect the idler gears 7, 8, 9, 10, 11, 12, 13, 14, 15, 16, 17 to the respective countershaft w_v1, w_v2, a plurality of activatable coupling devices A, B, C, D, E, F, G, H, I, K are provided on the countershafts w_v1, w_v2. Furthermore, output gears 20, 21 are disposed as constant pinions on the two countershafts w_v1, w_v2, the output gears being coupled in each case to gearing of a fixed gear 19 of an output shaft w_ab, wherein the output gears 20, 21 are associated with the corresponding output stages i_ab_1, i_ab_2.

In addition to the coupling devices A, B, C, D, E, F, G, H, I, K, which in the activated state implement a rotationally fixed connection between a toothed gearwheel and the associated countershaft w_v1, w_v2, winding path gear shift elements M and N or P are provided on the first and second countershafts w_v1, w_v2.

The shift element M is used to connect the idler gears 9 and 10 of the first countershaft w_v1 to one another in order to couple the first subtransmission to the second subtransmission such that the winding path gears can be shifted. The shift element N is used to connect the idler gears 15 and 16 of the second countershaft w_v2 to one another in order to couple the first subtransmission to the second subtransmission such that the winding path gears can be shifted. The shift element P is used to connect the idler gears 13 and 14 of the second countershaft w_v2 to one another in order to couple the first subtransmission to the second subtransmission such that the winding path gears can be shifted.

According to the invention, the double clutch transmission is provided with only four or five gear planes 7-13, 8-2, 8-12, 8-14, 9-13, 9-15, 10-14, 10-16, 11-4, 11-15, 11-17, 5-15, wherein in each variant embodiment at least three dual gear planes 7-13, 8-12, 8-14, 9-13, 9-15, 10-14, 10-16, 11-15, 11-17 are provided, so that winding path gears can be shifted at least when the shift elements M and N or P are activated, and if necessary also additionally by way of a further activated shift element and by way of at least one of the winding path gear coupling devices S_ab1, S_ab2. A claw or the like, for example, can be used as the shift elements M, N, P for connecting two gears.

When the coupling device S_ab1 or S_ab2 is disengaged, the rotationally fixed connection between the output gear 20 or 21 and the respective first countershaft w_v1 or the second countershaft w_v2 can be released.

In the 1st and 2nd variant embodiments according to FIGS. 1 to 4, with the first gear plane 8-12 as a dual gear plane, the fixed gear 1 of the second transmission input shaft w_k2 meshes with both the idler gear 8 of the first countershaft w_v1 and with the idler gear 12 of the second countershaft w_v2. With the second gear plane 9-13 as a dual gear plane, the fixed gear 2 of the second transmission input shaft w_k2 meshes with both the idler gear 9 of the first countershaft w_v1 and an intermediate gear ZR on an intermediate shaft w_zw for the purpose of rotation reversal for the reverse gear transmission ratios, wherein the intermediate gear ZR also meshes with the idler gear 13 of the second countershaft w_v2. With the third gear plane 10-14 as a dual gear plane, the fixed gear 3 of the first transmission input shaft w_k1 meshes with both the idler gear 10 of the first countershaft w_v1 and with the idler gear 14 of the second countershaft w_v2. Finally, with the fourth gear plane 11-15 as a dual gear plane, the fixed gear 4 of the first transmission input shaft w_k1 meshes with both the idler gear 11 of the first countershaft w_v1 and with the idler gear 15 of the second countershaft w_v2.

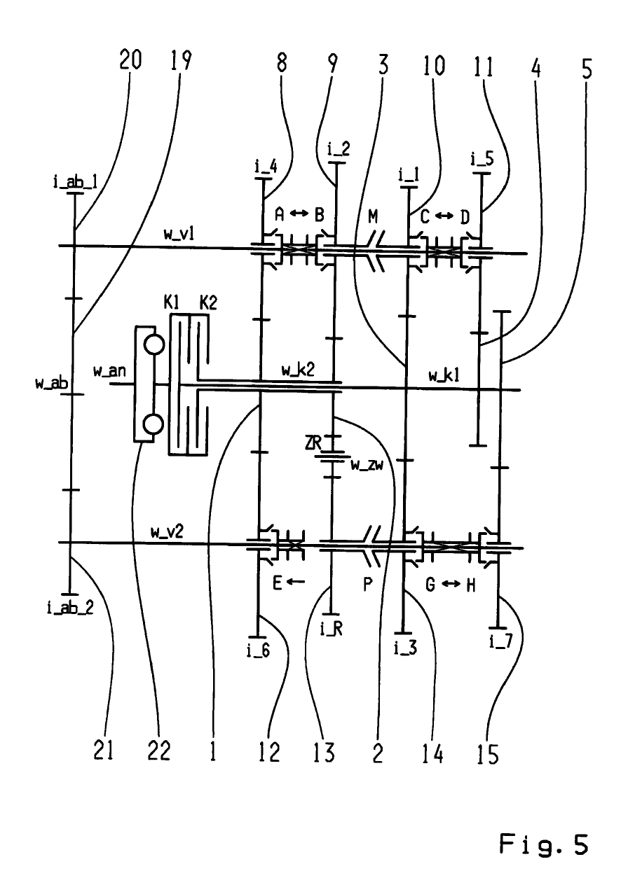

In the 3rd and 4th variant embodiments according to FIGS. 5 to 8, with the first gear plane 8-12 as a dual gear plane, the fixed gear 1 of the second transmission input shaft w_k2 meshes with both the idler gear 8 of the first countershaft w_v1 and with the idler gear 12 of the second countershaft w_v2. With the second gear plane 9-13 as a dual gear plane, the fixed gear 2 of the second transmission input shaft w_k2 meshes with both the idler gear 9 of the first countershaft w_v1 and with an intermediate gear ZR for the purpose of rotation reversal for the reverse gear transmission ratios, wherein the intermediate gear ZR also meshes with the idler gear 13 of the second countershaft w_v2. With the third gear plane 10-14 as a dual gear plane, the fixed gear 3 of the first transmission input shaft w_k1 meshes with both the idler gear 10 of the first countershaft w_v1 and with the idler gear 14 of the second countershaft w_v2. With the fourth gear plane 11-4 as a single gear plane, the fixed gear 4 of the first transmission input shaft w_k1 meshes with the idler gear 11 of the first countershaft w_v1. Finally, with the fifth gear plane 5-15 as a single gear plane, the fixed gear 5 of the first transmission input shaft w_k1 meshes with the idler gear 15 of the second countershaft w_v2.

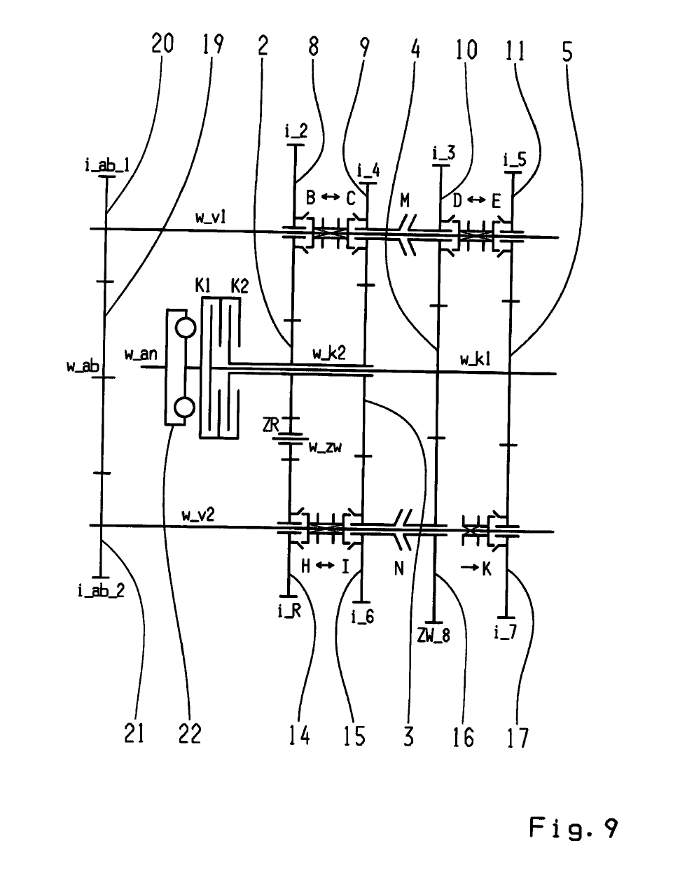

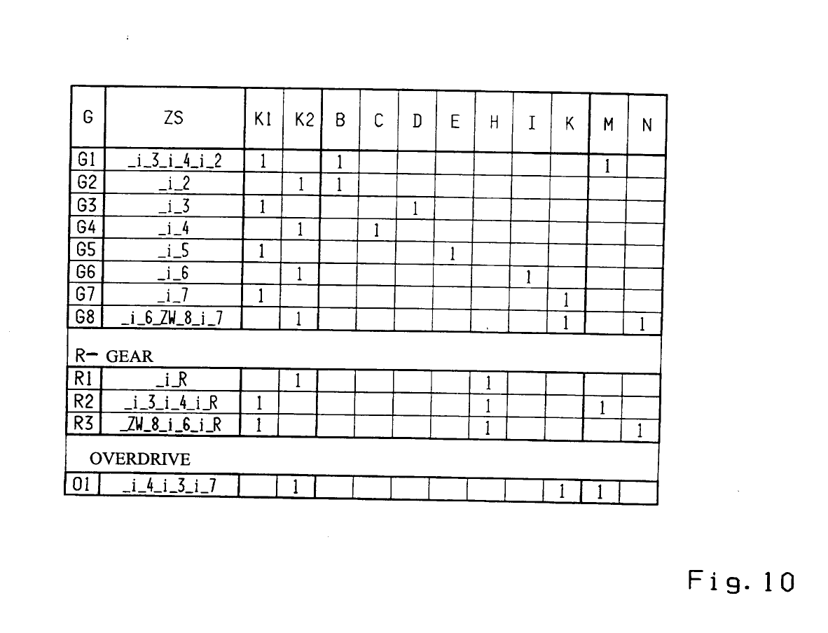

In the 5th variant embodiment according to FIGS. 9 and 10, with the first gear plane 8-14 as a dual gear plane, the fixed gear 2 of the second transmission input shaft w_k2 meshes with both the idler gear 8 of the first countershaft w_v1 and with the intermediate gear ZR for the purpose of rotation reversal for the reverse gear transmission ratios, wherein the intermediate gear ZR also meshes with the idler gear 14 of the second countershaft w_v2. With the second gear plane 9-15 as a dual gear plane, the fixed gear 3 of the second transmission input shaft w_k2 meshes with both the idler gear 9 of the first countershaft w_v1 and with the idler gear 15 of the second countershaft w_v2. With the third gear plane 10-16 as a dual gear plane, the fixed gear 4 of the first transmission input shaft w_k1 meshes with both the idler gear 10 of the first countershaft w_v1 and with the idler gear 16 of the second countershaft w_v2. Finally, with the fourth gear plane 11-17 as a dual gear plane, the fixed gear 5 of the first transmission input shaft w_k1 meshes with both the idler gear 11 of the first countershaft w_v1 and with the idler gear 17 of the second countershaft w_v2.

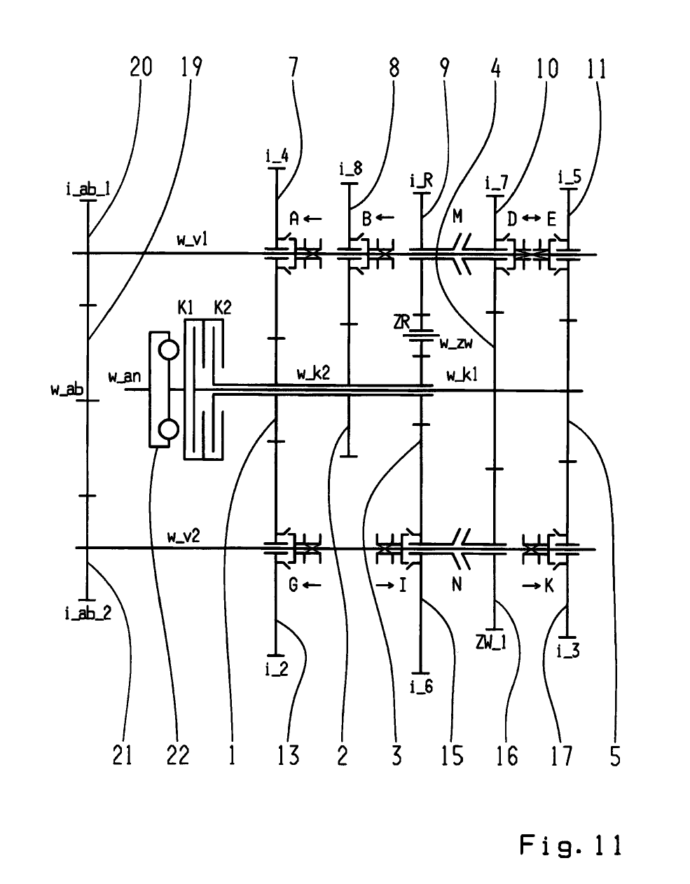

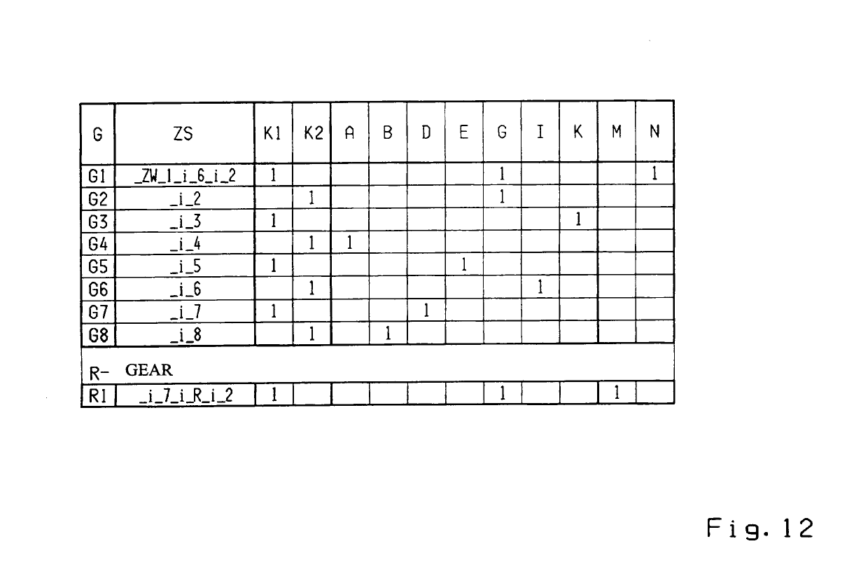

In the 6th variant embodiment according to FIGS. 11 to 12, with the first gear plane 7-13 as a dual gear plane, the fixed gear 1 of the second transmission input shaft w_k2 meshes with both the idler gear 7 of the first countershaft w_v1 and with the idler gear 13 of the second countershaft w_v2. In the second gear plane 8-2 as a single gear plane, the fixed gear 2 of the second transmission input shaft w_k2 meshes with the idler gear 8 of the first countershaft w_v1. With the third gear plane 9-15 as a dual gear plane, the fixed gear 3 of the second transmission input shaft w_k2 meshes with both the idler gear 15 of the second countershaft w_v2 and with the intermediate gear ZR for the purpose of rotation reversal for the reverse gear transmission ratios, wherein the intermediate gear ZR also meshes with the idler gear 9 of the first countershaft w_v1. With the fourth gear plane 10-16 as a dual gear plane, the fixed gear 4 of the first transmission input shaft w_k1 meshes with both the idler gear 10 of the first countershaft w_v1 and with the idler gear 16 of the second countershaft w_v2. Finally, with the fifth gear plane 11-17 as a dual gear plane, the fixed gear 5 of the first transmission input shaft w_k1 meshes with both the idler gear 11 of the first countershaft w_v1 and with the idler gear 17 of the second countershaft w_v2.

In the 1st, 2nd, 3rd, and 4th variant embodiments according to FIGS. 1 to 8, two dual acting coupling devices A-B and C-D are supported on the first countershaft w_v1, wherein the coupling devices A-B and C-D are disposed such that the activated coupling device A rigidly connects the idler gear 8, the activated coupling device B rigidly connects the idler gear 9, the activated coupling device C rigidly connects the idler gear 10, and the activated coupling device D rigidly connects the idler gear 11 to the first countershaft w_v1. Furthermore, a dual acting coupling device G-H and a single acting coupling device E are supported on the second countershaft w_v2, which are disposed such that the activated coupling device E rigidly connects the idler gear 12, the activated coupling device G rigidly connects the idler gear 14, and the activated coupling device H rigidly connects the idler gear 15 to the second countershaft w_v2.

In the 5th variant embodiment according to FIGS. 9 and 10, two dual acting coupling devices B-C and D-E are supported on the first countershaft w_v1, and disposed such that the activated coupling device B rigidly connects the idler gear 8, the activated coupling device C rigidly connects the idler gear 9, the activated coupling device D rigidly connects the idler gear 10, and the activated coupling device E rigidly connects the idler gear 11 to the first countershaft w_v1. A dual acting coupling device H-I and a single acting coupling device K are supported on the second countershaft, which are disposed such that the activated coupling device H rigidly connects the idler gear 14, the activated coupling devices I rigidly connects the idler gear 15, and the activated coupling device K rigidly connects the idler gear 17 to the second countershaft w_v2.

In the 6th variant embodiment according to FIGS. 11 and 12, a dual acting coupling device D-E and two single acting coupling devices A and B are supported on the first countershaft w_v1, which are disposed such that the activated coupling device A rigidly connects the idler gear 7, the activated coupling device B rigidly connects the idler gear 8, the activated coupling device D rigidly connects the idler gear 10, and the activated coupling device E rigidly connects the idler gear 11 to the first countershaft w_v1. Three single acting coupling devices G, I, and K are supported on the second countershaft w_v2, which are disposed such that the activated coupling device G rigidly connects the idler gear 13, the activated coupling device I rigidly connects the idler gear 15, and the activated coupling device K rigidly connects the idler gear 17 to the second countershaft w_v2.

Independent of the respective variant embodiments, the double clutch transmission according to the invention is provided with an integrated output stage comprising the output gear 20 and the output gear 21. The output gears 20, 21 each mesh with a fixed gear 19 of the output shaft w_ab. Optionally, shiftable connections can be implemented between the output gears 20, 21 and the associated countershafts w_v1, w_v2 by shiftable coupling devices S_ab1, S_ab2.

Furthermore, in the double clutch transmission according to the invention at least the forward gears G1 to G8 are designed to be power shiftable. Depending on the variant embodiment, additionally at least one reverse gear and/or crawler gears and/or overdrive gears can be implemented in a power shiftable manner, for example as winding path gears. Details for each variant embodiment will be apparent from the shift patterns described hereinafter.

The table illustrated in FIG. 2 shows, by way of example, a shift pattern for the 1st variant embodiment of the eight-speed double clutch transmission according to FIG. 1.

From the shift pattern, it is apparent that the first forward gear G1 can be shifted by the first clutch K1 and by the activated coupling device D, the second forward gear G2 can be shifted by the second clutch K2 and by the activated coupling device A, the third forward gear G3 can be shifted by the first clutch K1 and by the activated coupling device H, the fourth forward gear G4 can be shifted by the second clutch K2 and by the activated coupling device E, the fifth forward gear G5 can be shifted by the first clutch K1 and by the activated coupling device C, the sixth forward gear G6 can be shifted by the second clutch K2 and by the activated coupling device B, the seventh forward gear G7 can be shifted by the first clutch K1 and by the activated coupling device G, and the eighth forward gear G8 can be shifted by the second clutch K2 and by the activated coupling device G and as the winding path gear by the activated shift element M. In this way, at least the first eight forward gears can be implemented as power shiftable (psh.)

In addition, for example, a reverse gear R1 can be shifted by the first clutch K1 and by the activated coupling device A and as the winding path gear by the activated shift element P. A reverse gear R2 can be shifted by the first clutch K1, by the activated coupling device A, by the activated coupling device F, and by the activated coupling device H, and as a winding path gear with the coupling device S_ab2 being disengaged. Furthermore, a reverse gear R3 can be shifted by the first clutch K1, by the activated coupling device B, by the activated coupling device F, and by the activated coupling device H, and as a winding path gear with the winding path gear coupling device S_ab2 being disengaged.

In addition, it is apparent from the shift pattern according to FIG. 2 that a crawler gear C1 can be shifted by the second clutch K2 and by the activated coupling device A, by the activated coupling device C, and by the activated coupling device H, and as a winding path gear with the winding path gear coupling device S_ab1 being disengaged. A crawler gear C2 can be shifted by the second clutch K2 and by the activated coupling device D, by the activated coupling device E, and by the activated coupling device G, and as a winding path gear with the winding path gear coupling device S_ab2 being disengaged. A crawler gear C3 can be shifted by the first clutch K1 and by the activated coupling device A and as a winding path gear by the activated shift element M A crawler gear C4 can be shifted by the first clutch K1, by the activated coupling device B, by the activated coupling device D, and by the activated coupling device E, and as a winding path gear with the winding path gear coupling device S_ab1 being disengaged. Advantageously, the crawler gear C2 can be implemented to be power shiftable, in particular relative to the first forward gear G1.

Finally, an overdrive gear O1 can be shifted by the second clutch K2, by the activated coupling device B, by the activated coupling device D, and by the activated coupling device G, and as a winding path gear with the coupling device S_ab1 being disengaged. An overdrive gear O2 can be shifted by the first clutch K1, by the activated coupling device B, by the activated coupling device E, and by the activated coupling device G, and as a winding path gear with the winding path gear coupling device S_ab2 being disengaged.

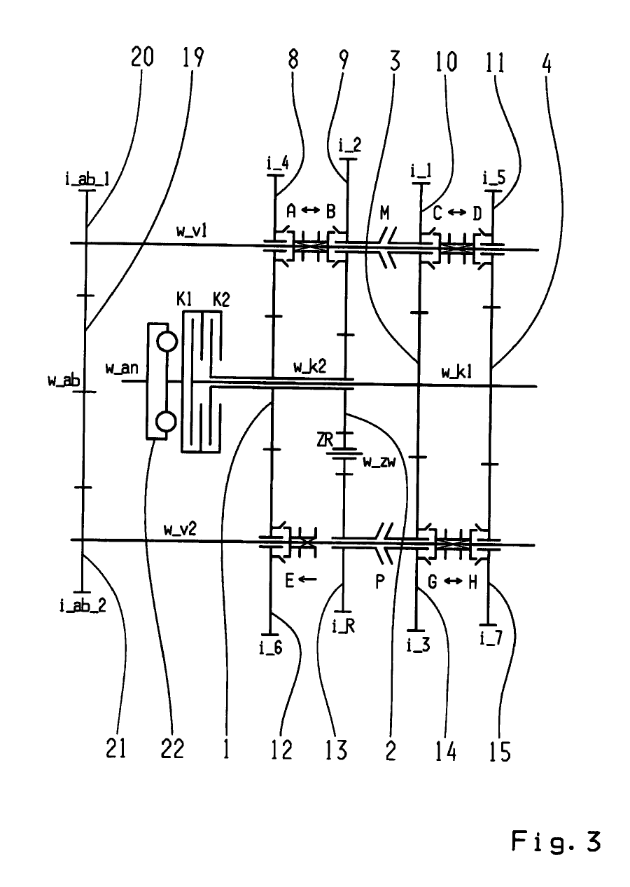

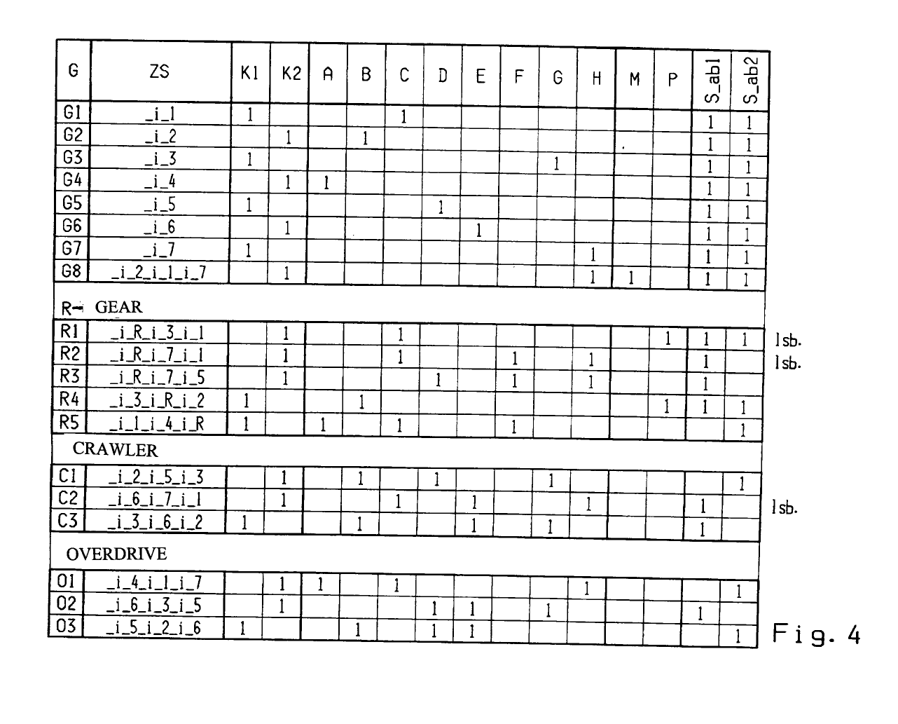

The table illustrated in FIG. 4 shows, by way of example, a shift pattern for the 2nd variant embodiment of the eight-speed double clutch transmission according to FIG. 3.

From the shift pattern it is apparent, that the first forward gear G1 can be shifted by the first clutch K1 and by the activated coupling device C, the second forward gear G2 can be shifted by the second clutch K2 and by the activated coupling device B, the third forward gear G3 can be shifted by the first clutch K1 and by the activated coupling device G, the fourth forward gear G4 can be shifted by the second clutch K2 and by the activated coupling device A, the fifth forward gear G5 can be shifted by the first clutch K1 and by the activated coupling device D, the sixth forward gear G6 can be shifted by the second clutch K2 and by the activated coupling device E, the seventh forward gear G7 can be shifted by the first clutch K1 and by the activated coupling device H, and the eighth forward gear G8 can be shifted by the second clutch K2 and the activated coupling device H and as a winding path gear by the activated shift element M. In this way, at least the first eight forward gears can be implemented as power shiftable (psh.)

In addition, for example, a reverse gear R1 can be shifted by the second clutch K2 and by the activated coupling device C and as a winding path gear by the activated shift element P. A reverse gear R2 can be shifted by the second clutch K2, by the activated coupling device C, by the activated coupling device F, and by the activated coupling device H, and as a winding path gear when disengaged coupling device S_ab2 is disengaged. Furthermore, a reverse gear R3 can be shifted by the second clutch K2, by the activated coupling device D, by the activated coupling device F, and by the activated coupling device H, and as a winding path gear with the winding path gear coupling device S_ab2 being disengaged. A further reverse gear R4 can be shifted by the first clutch K1 and by the activated coupling device B and as a winding path gear by the activated shift element P. A reverse gear R5 can be shifted by the first clutch K1, by the activated coupling device A, by the activated coupling device C, and by the activated coupling device F, and as a winding path gear with the coupling device S_ab1 being disengaged. Advantageously, the reverse gears R1, R2 can be implemented to be power shiftable, in particular relative to the first forward gear G1.

In addition, it is apparent from the shift pattern according to FIG. 4 that a crawler gear C1 can be shifted by the second clutch K2 and by the activated coupling device B, by the activated coupling device D, and by the activated coupling device G, and as a winding path gear with the winding path gear coupling device S_ab1 being disengaged. A crawler gear C2 can be shifted by the second clutch K2 and by the activated coupling device C, by the activated coupling device E, and by the activated coupling device H, and as a winding path gear with the winding path gear coupling device S_ab2 being disengaged. A crawler gear C3 can be shifted by the first clutch K1, by the activated coupling device B, by the activated coupling device E, and by the activated coupling device G, and as a winding path gear with the coupling device S_ab2 being disengaged. Advantageously, the crawler gear C2 can be implemented as power shiftable, in particular relative to the first forward gear G1

Finally, an overdrive gear O1 can be shifted by the second clutch K2, by the activated coupling device A, by the activated coupling device C, and by the activated coupling device H, and as a winding path gear with the coupling device S_ab1 being disengaged. An overdrive gear O2 can be shifted by the second clutch K2, by the activated coupling device D, by the activated coupling device E, and by the activated coupling device G, and as a winding path gear with the coupling device S_ab2 being disengaged. An overdrive gear O3 can be shifted by the first clutch K1, by the activated coupling device B, by the activated coupling device D, and by the activated coupling device E, and as a winding path gear with the winding path gear coupling device S_ab1 being disengaged.

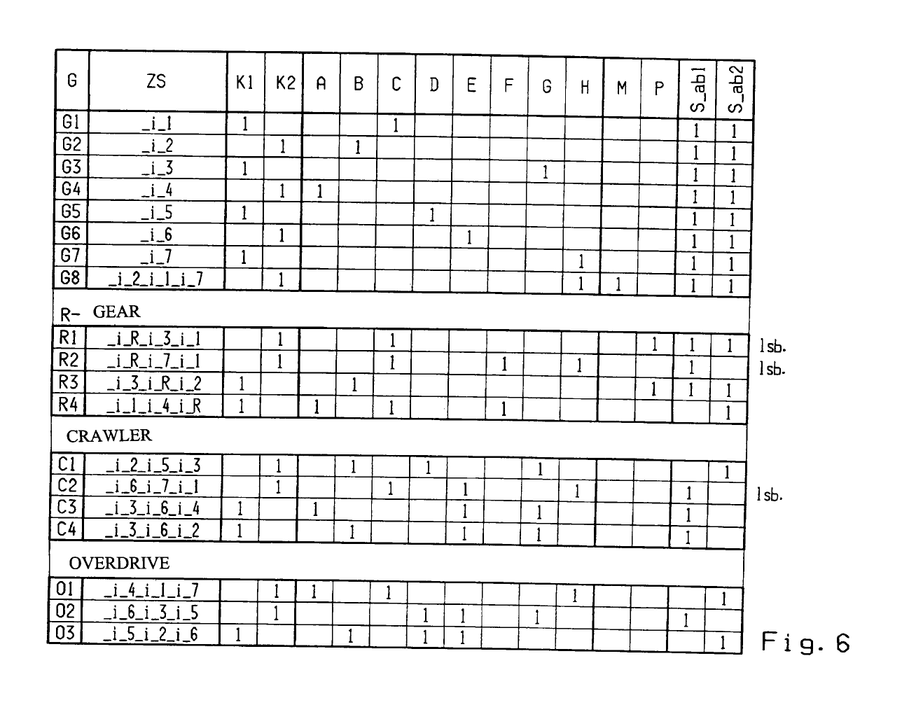

The table illustrated in FIG. 6 shows, by way of example, a shift pattern for the 3rd variant embodiment of the eight-speed double clutch transmission according to FIG. 5.

From the shift pattern it is apparent, that the first forward gear G1 can be shifted by the first clutch K1 and by the activated coupling device C, the second forward gear G2 can be shifted by the second clutch K2 and by the activated coupling device B, the third forward gear G3 can be shifted by the first clutch K1 and by the activated coupling device G, the fourth forward gear G4 can be shifted by the second clutch K2 and by the activated coupling device A, the fifth forward gear G5 can be shifted by the first clutch K1 and by the activated coupling device D, the sixth forward gear G6 can be shifted by the second clutch K2 and by the activated coupling device E, the seventh forward gear G7 can be shifted by the first clutch K1 and by the activated coupling device H, and the eighth forward gear G8 can be shifted by the second clutch K2 and by the activated coupling device H and as a winding path gear by the activated shift element M. In this way, at least the first eight forward gears can be implemented as power shiftable (psh.)

Furthermore, for example, a reverse gear R1 can be shifted by the second clutch K2 and by the activated coupling device C and as a winding path gear by the activated shift element P. A reverse gear R2 can be shifted by the second clutch K2, by the activated coupling device C, by the activated coupling device F, and by the activated coupling device H, and as a winding path gear with the coupling device S_ab2 being disengaged. Furthermore, a reverse gear R3 can be shifted by the first clutch K1 and by the activated coupling device B, and as a winding path gear with the shift element P being activated. A further reverse gear R4 can be shifted by the first clutch K1, by the activated coupling device A, by the activated coupling device C, and by the activated coupling device F, and as a winding path gear with the coupling device S_ab1 being disengaged. Advantageously, the reverse gears R1, R2 can be implemented as power shiftable, in particular relative to the first forward gear G1.

In addition, it is apparent from the shift pattern according to FIG. 6 that a crawler gear C1 can be shifted by the second clutch K2 and by the activated coupling device B, by the activated coupling device D, and by the activated coupling device G, and as a winding path gear with the winding path gear coupling device S_ab1 being disengaged. A crawler gear C2 can be shifted by the second clutch K2 and by the activated coupling device C, by the activated coupling device E, and by the activated coupling device H, and as a winding path gear with the winding path gear coupling device S_ab2 being disengaged. A crawler gear C3 can be shifted by the first clutch K1, by the activated coupling device A, by the activated coupling device E, and by the activated coupling device G, and as a winding path gear with the coupling device S_ab2 being disengaged. A crawler gear C4 can be shifted by the first clutch K1, by the activated coupling device B, by the activated coupling device E, and by the activated coupling device G, and as a winding path gear with the coupling device S_ab2 being disengaged. Advantageously, the crawler gear C2 can be implemented as power shiftable, in particular relative to the first forward gear G1

Finally, an overdrive gear O1 can be shifted by the second clutch K2, by the activated coupling device A, by the activated coupling device C, and by the activated coupling device H, and as a winding path gear with the coupling device S_ab1 being disengaged. An overdrive gear O2 can be shifted by the second clutch K2, by the activated coupling device D, by the activated coupling device E, and by the activated coupling device G, and as a winding path gear with the coupling device S_ab2 being disengaged. An overdrive gear O3 can be shifted by the first clutch K1, by the activated coupling device B, by the activated coupling device D, and by the activated coupling device E, and as a winding path gear with the winding path gear coupling device S_ab1 being disengaged.

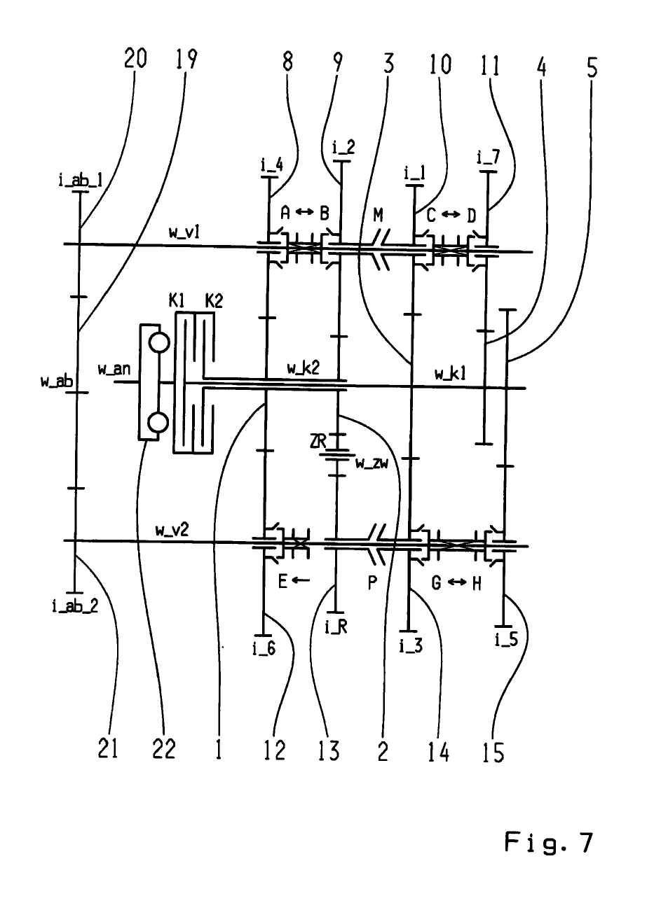

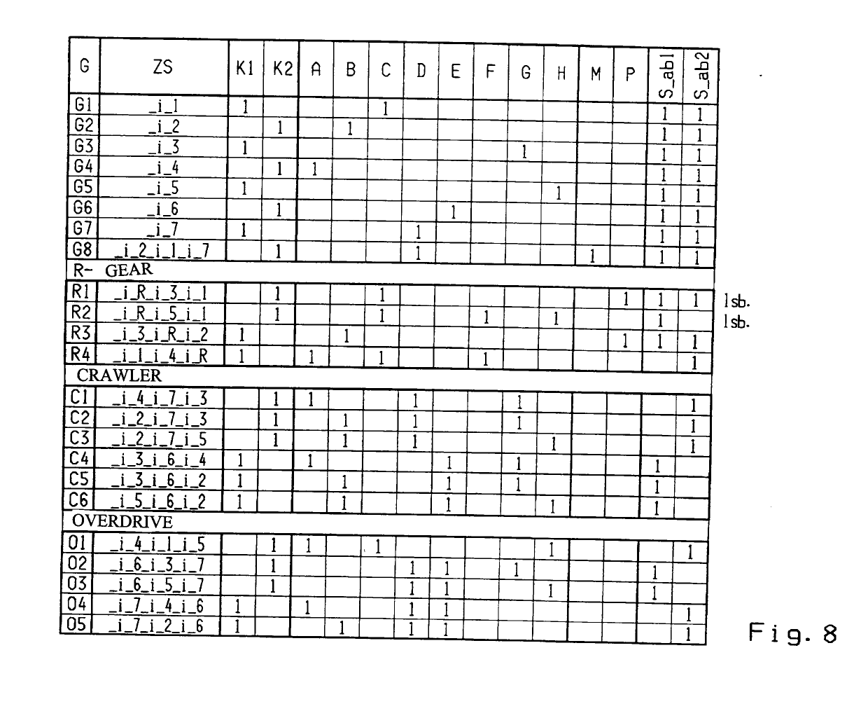

The table illustrated in FIG. 8 shows, by way of example, a shift pattern for the 4th variant embodiment of the eight-speed double clutch transmission according to FIG. 7.

From the shift pattern it is apparent, that the first forward gear G1 can be shifted by the first clutch K1 and by the activated coupling device C, the second forward gear G2 can be shifted by the second clutch K2 and by the activated coupling device B, the third forward gear G3 can be shifted by the first clutch K1 and by the activated coupling device G, the fourth forward gear G4 can be shifted by the second clutch K2 and by the activated coupling device A, the fifth forward gear G5 can be shifted by the first clutch K1 and by the activated coupling device H, the sixth forward gear G6 can be shifted by the second clutch K2 and by the activated coupling device E, the seventh forward gear G7 can be shifted by the first clutch K1 and by the activated coupling device D, and the eighth forward gear G8 can be shifted by the second clutch K2 and the activated coupling device D and as a winding path gear by the activated shift element M. In this way, at least the first eight forward gears as implemented to be power shiftable (psh.)

Furthermore, for example, a reverse gear R1 can be shifted by the second clutch K2 and by the activated coupling device C and as a winding path gear by the activated shift element P. A reverse gear R2 can be shifted by the second clutch K2, by the activated coupling device C, by the activated coupling device F, and by the activated coupling device H, and as a winding path gear with the coupling device S_ab2 being disengaged. Furthermore, a reverse gear R3 can be shifted by the first clutch K1 and by the activated coupling device B, and as a winding path gear with the shift element P being activated. A further reverse gear R4 can be shifted by the first clutch K1, by the activated coupling device A, by the activated coupling device C, and by the activated coupling device F, and as a winding path gear with the coupling device S_ab1 being disengaged. Advantageously, the reverse gears R1, R2 can be implemented as power shiftable, in particular relative to the first forward gear G1.

In addition, it is apparent from the shift pattern according to FIG. 8 that a crawler gear C1 can be shifted by the second clutch K2 and by the activated coupling device A, by the activated coupling device D, and by the activated coupling device G, and as a winding path gear with the winding path gear coupling device S_ab1 being disengaged. A crawler gear C2 can be shifted by the second clutch K2 and by the activated coupling device B, by the activated coupling device D, and by the activated coupling device G, and as a winding path gear with the winding path gear coupling device S_ab1 being disengaged. A crawler gear C3 can be shifted by the second clutch K2, by the activated coupling device B, by the activated coupling device D, and by the activated coupling device H, and as a winding path gear with the coupling device S_ab1 being disengaged. A crawler gear C4 can be shifted by the first clutch K1, by the activated coupling device A, by the activated coupling device E, and by the activated coupling device G, and as a winding path gear with the coupling device S_ab2 being disengaged. A crawler gear C5 can be shifted by the first clutch K1, by the activated coupling device B, by the activated coupling device E, and by the activated coupling device G, and as a winding path gear with the coupling device S_ab2 being disengaged. A crawler gear C6 can be shifted by the first clutch K1, by the activated coupling device B, by the activated coupling device E, and by the activated coupling device H, and as a winding path gear with the coupling device S_ab2 being disengaged.

Finally, an overdrive gear O1 can be shifted by the second clutch K2, by the activated coupling device A, by the activated coupling device C, and by the activated coupling device H, and as a winding path gear with the coupling device S_ab1 being disengaged. An overdrive gear O2 can be shifted by the second clutch K2, by the activated coupling device D, by the activated coupling device E, and by the activated coupling device G, and as a winding path gear with the coupling device S_ab2 being disengaged. An overdrive gear O3 can be shifted by the second clutch K2, by the activated coupling device D, by the activated coupling device E, and by the activated coupling device H, and as a winding path gear with the winding path gear coupling device S_ab2 being disengaged. An overdrive gear O4 can be shifted by the first clutch K1, by the activated coupling device A, by the activated coupling device D, and by the activated coupling device E, and as a winding path gear with the coupling device S_ab1 being disengaged. An overdrive gear O5 can be shifted by the first clutch K1, by the activated coupling device B, by the activated coupling device D, and by the activated coupling device E, and as a winding path gear with the coupling device S_ab1 being disengaged.

The table illustrated in FIG. 10 shows, by way of example, a shift pattern for the 5th variant embodiment of the eight-speed double clutch transmission according to FIG. 9.

From the shift pattern it is apparent, that the first forward gear G1 can be shifted by the first clutch K1 and by the activated coupling device B and as a winding path gear by the activated shift element M, the second forward gear G2 can be shifted by the second clutch K2 and by the activated coupling device B, the third forward gear G3 can be shifted by the first clutch K1 and by the activated coupling device D, the fourth forward gear G4 can be shifted by the second clutch K2 and by the activated coupling device C, the fifth forward gear G5 can be shifted by the first clutch K1 and the activated coupling device E, the sixth forward gear G6 can be shifted by the second clutch K2 and by the activated coupling device I, the seventh forward gear G7 can be shifted by the first clutch K1 and the activated coupling device K, and the eighth forward gear G8 can be shifted by the second clutch K2 and the activated coupling device K and as a winding path gear by the activated shift element N. In this way, at least the first eight forward gears can be implemented as power shiftable (psh.).

Furthermore, for example, a reverse gear R1 can be shifted by the second clutch K2 and by the activated coupling device H. A reverse gear R2 can be shifted by the first clutch K1 and by the activated coupling device H, and as a winding path gear with the shift element M being activated. A further reverse gear R3 can be shifted by the first clutch K1 and by the activated coupling device H, and as a winding path gear with the shift element N being activated.

Finally, an overdrive gear O1 can be shifted by the second clutch K2 and by the activated coupling device K, and as a winding path gear with the shift element M being activated.

The table illustrated in FIG. 12 shows, by way of example, a shift pattern for the 6th variant embodiment of the eight-speed double clutch transmission according to FIG. 11.

From the shift pattern it is apparent, that the first forward gear G1 can be shifted by the first clutch K1 and by the activated coupling device G and as a winding path gear by the activated shift element N, the second forward gear G2 can be shifted by the second clutch K2 and by the activated coupling device G, the third forward gear G3 can be shifted by the first clutch K1 and by the activated coupling device K, the fourth forward gear G4 can be shifted by the second clutch K2 and by the activated coupling device A, the fifth forward gear G5 can be shifted by the first clutch K1 and the activated coupling device E, the sixth forward gear G6 can be shifted by the second clutch K2 and by the activated coupling device I, the seventh forward gear G7 can be shifted by the first clutch K1 and the activated coupling device D, and the eighth forward gear G8 can be shifted by the second clutch K2 and the activated coupling device B. In this way, at least the first eight forward gears can be implemented as power shiftable.

In addition, a reverse gear R1 can be shifted by the first clutch K1 and by the activated coupling device G and as a winding path gear by the activated shift element M.

From the shift pattern of the 1st variant embodiment according to FIG. 2, it is apparent in detail that, starting from the first clutch K1, in the first forward gear G1 the gear stage i_1, in the second forward gear G2 the gear stage i_2, in the third forward gear G3 the gear stage i_3, in the fourth forward gear G4 the gear stage i_4, in the fifth forward gear G5 the gear stage i_5, in the sixth forward gear G6 the gear stage i_6, in the seventh forward gear G7 the gear stage i_7, and, starting from the second clutch K2, in the eighth forward gear G8 the gear stages i_6, i_5, and i_7 are used, wherein the two subtransmissions are coupled to one another by the activated shift element M.

In the shift pattern of the 1st variant embodiment according to FIG. 2, additionally, starting from the first clutch K1, in the reverse gear R1 the gear stages i_7, i_R, and i_2 are used, wherein the two subtransmissions are coupled to one another by the activated shift element P. Furthermore, starting from the first clutch K1, in a further reverse gear R2 the gear stages i_3, i_R, and i_2 are used, wherein a winding path gear coupling device S_ab2 is disengaged in order to couple the two subtransmissions. Starting from the first clutch K1, in the reverse gear R3 the gear stages i_3, i_R, and i_6 are used, wherein a winding path gear coupling device S_ab2 is disengaged in order to couple the two subtransmissions.

Starting from the second clutch K2, in the crawler gear C1 the gear stages i_2, i_5, and i_3 are used, wherein the two subtransmissions are coupled with the winding path gear coupling device S_ab1 being disengaged. Starting from the second clutch K2, in the crawler gear C2 the gear stages i_4, i_7, and i_1 are used, wherein the two subtransmissions are coupled to one another with the coupling device S_ab2 being disengaged. Starting from the first clutch K1, in the crawler gear C3 the gear stages i_5, i_6, and i_2 are used, wherein the two subtransmissions are coupled with the shift element M being activated. Starting from the first clutch K1, in the crawler gear C4 the gear stages i_1, i_6, and i_4 are used, wherein the two subtransmissions are coupled to one another with the winding path gear coupling device S_ab1 being disengaged.

Starting from the second clutch K2, in the overdrive gear O1 the gear stages i_6, i_1, and i_7 are used, wherein the two subtransmissions are coupled with the coupling device S_ab1 being disengaged. Starting from the first clutch K1, in the overdrive gear O2 the gear stages i_7, i_4, and i_6 are used, wherein the two subtransmissions are coupled with the winding path gear coupling device S_ab2 being disengaged.

From the shift patterns of the 2nd to the 4th variant embodiments according to FIGS. 3 to 8, it is apparent in detail that, starting from the first clutch K1, in the first forward gear G1 the gear stage i_1, in the second forward gear G2 the gear stage i_2, in the third forward gear G3 the gear stage i_3, in the fourth forward gear G4 the gear stage i_4, in the fifth forward gear G5 the gear stage i_5, in the sixth forward gear G6 the gear stage i_6, in the seventh forward gear G7 the gear stage i_7, and, starting from the second clutch, in the eighth forward gear G8 the gear stages i_2, i_1, and i_7 are used, wherein the two subtransmissions are coupled to one another by the activated shift element M.

From the shift pattern according to FIG. 4, it is apparent that, starting from the second clutch K2, in the reverse gear R1 the gear stages i_R, i_3, and i_1 are used, wherein the two subtransmissions are coupled to one another by the activated shift element P. Furthermore, starting from the second clutch K2, in the further reverse gear R2 the gear stages i_R, i_7, and i_1 are used, wherein the coupling device S_ab2 is disengaged in order to couple the two subtransmissions. Starting from the second clutch K2, in the reverse gear R3 the gear stages i_R, i_7, and i_5 are used, wherein the coupling device S_ab2 is disengaged in order to couple the two subtransmissions. Starting from the first clutch K1, in the reverse gear R4 the gear stages i_3, i_R, and i_2 are used, wherein the two subtransmissions are coupled to one another by the activated shift element P. Starting from the first clutch K1, in the reverse gear R5 the gear stages i_1, i_4, and i_R are used, wherein the coupling device S_ab1 is disengaged in order to couple the two subtransmissions.

Starting from the second clutch K2, in the crawler gear C1 the gear stages i_2, i_5, and i_3 are used, wherein the two subtransmissions are coupled with the winding path gear coupling device S_ab1 being disengaged. Starting from the second clutch K2, in the crawler gear C2 the gear stages i_6, i_7, and i_1 are used, wherein the two subtransmissions are coupled with the coupling device S_ab2 being disengaged. Starting from the first clutch K1, in the crawler gear C3 the gear stages i_3, i_6, and i_2 are used, wherein the two subtransmissions are coupled with the coupling device S_ab2 being disengaged.

Starting from the second clutch K2, in the overdrive gear O1 the gear stages i_4, i_1, and i_7 are used, wherein the two subtransmissions are coupled with the coupling device S_ab1 being disengaged. Starting from the second clutch K2, in the overdrive gear O2 the gear stages i_6, i_3, and i_5 are used, wherein the two subtransmissions are coupled with the winding path gear coupling device S_ab2 being disengaged. Starting from the first clutch K1, in the overdrive gear O3 the gear stages i_5, i_2, and i_6 are used, wherein the two subtransmissions are coupled with the coupling device S_ab1 being disengaged.

From the shift pattern according to FIG. 6, it is also apparent that, starting from the second clutch K2, in the reverse gear R1 the gear stages i_R, i_3, and i_1 are used, wherein the two subtransmissions are coupled to one another by the activated shift element P. Furthermore, starting from the second clutch K2, in the further reverse gear R2 the gear stages i_R, i_7, and i_1 are used, wherein the coupling device S_ab2 is disengaged in order to couple the two subtransmissions. Starting from the first clutch K1, in the reverse gear R3 the gear stages i_3, i_R, and i_2 are used, wherein the two subtransmissions are coupled to one another by the activated shift element P. Starting from the first clutch K1, in the reverse gear R4 the gear stages i_1, i_4, and i_R are used, wherein the coupling device S_ab1 is disengaged in order to couple the two subtransmissions.

Starting from the second clutch K2, in the crawler gear C1 the gear stages i_2, i_5, and i_3 are used, wherein the two subtransmissions are coupled with the winding path gear coupling device S_ab1 being disengaged. Starting from the second clutch K2, in the crawler gear C2 the gear stages i_6, i_7, and i_1 are used, wherein the two subtransmissions are coupled with the coupling device S_ab2 being disengaged. Starting from the first clutch K1, in the crawler gear C3 the gear stages i_3, i_6, and i_4 are used, wherein the two subtransmissions are coupled with the coupling device S_ab2 being disengaged. Starting from the first clutch K1, in the crawler gear C4 the gear stages i_3, i_6, and i_2 are used, wherein the two subtransmissions are coupled with the coupling device S_ab2 being disengaged.

Starting from the second clutch K2, in the overdrive gear O1 the gear stages i_4, i_1, and i_7 are used, wherein the two subtransmissions are coupled with the coupling device S_ab1 being disengaged. Starting from the second clutch K2, in the overdrive gear O2 the gear stages i_6, i_3, and i_5 are used, wherein the two subtransmissions are coupled with the winding path gear coupling device S_ab2 being disengaged. Starting from the first clutch K1, in the overdrive gear O3 the gear stages i_5, i_2, and i_6 are used, wherein the two subtransmissions are coupled with the coupling device S_ab1 being disengaged.

From the shift pattern according to FIG. 8, it is also apparent that, starting from the second clutch K2, in the reverse gear R1 the gear stages i_R, i_3, and i_1 are used, wherein the two subtransmissions are coupled to one another by the activated shift element P. Furthermore, starting from the second clutch K2, in the further reverse gear R2 the gear stages i_R, i_5, and i_1 are used, wherein the coupling device S_ab2 is disengaged in order to couple the two subtransmissions. Starting from the first clutch K1, in the reverse gear R3 the gear stages i_3, i_R, and i_2 are used, wherein the two subtransmissions are coupled to one another by the activated shift element P. Starting from the first clutch K1, in the reverse gear R4 the gear stages i_1, i_4, and i_R are used, wherein the coupling device S_ab1 is disengaged in order to couple the two subtransmissions.

Starting from the second clutch K2, in the crawler gear C1 the gear stages i_4, i_7, and i_3 are used, wherein the two subtransmissions are coupled with the winding path gear coupling device S_ab1 being disengaged. Starting from the second clutch K2, in the crawler gear C2 the gear stages i_2, i_7, and i_3 are used, wherein the two subtransmissions are coupled with the coupling device S_ab1 being disengaged. Starting from the second clutch K2, in the crawler gear C3 the gear stages i_2, i_7, and i_5 are used, wherein the two subtransmissions are coupled with the coupling device S_ab1 being disengaged. Starting from the first clutch K1, in the crawler gear C4 the gear stages i_3, i_6, and i_4 are used, wherein the two subtransmissions are coupled with the coupling device S_ab2 being disengaged. Starting from the first clutch K1, in the crawler gear C5 the gear stages i_3, i_6, and i_2 are used, wherein the two subtransmissions are coupled with the coupling device S_ab2 being disengaged. Starting from the first clutch K1, in the crawler gear C6 the gear stages i_5, i_6, and i_2 are used, wherein the two subtransmissions are coupled with the coupling device S_ab2 being disengaged.

Starting from the second clutch K2, in the overdrive gear O1 the gear stages i_4, i_1, and i_5 are used, wherein the two subtransmissions are coupled with the coupling device S_ab1 being disengaged. Starting from the second clutch K2, in the overdrive gear O2 the gear stages i_6, i_3, and i_7 are used, wherein the two subtransmissions are coupled with the winding path gear coupling device S_ab2 being disengaged. Starting from the second clutch K2, in the overdrive gear O3 the gear stages i_6, i_5, and i_7 are used, wherein the two subtransmissions are coupled with the winding path gear coupling device S_ab2 being disengaged. Starting from the first clutch K1, in the overdrive gear O4 the gear stages i_7, i_4, and i_6 are used, wherein the two subtransmissions are coupled with the coupling device S_ab1 being disengaged. Starting from the first clutch K1, in the overdrive gear O5 the gear stages i_7, i_2, and i_6 are used, wherein the two subtransmissions are coupled with the coupling device S_ab1 being disengaged.

From the shift pattern of the 5th variant embodiment according to FIG. 10, it is apparent that, starting from the first clutch K1, in the first forward gear G1 the gear stages i_3, i_4, and i_2 are used, wherein the two subtransmissions are coupled to one another by the activated shift element M. In the second forward gear G2 the gear stage i_2, in the third forward gear G3 the gear stage i_3, in the fourth gear G4 the gear stage i_4, in the fifth gear G5 the gear stage i_5, in the sixth gear G6 the gear stage i_6, in the seventh forward gear G7 the gear stage i_7, and, starting with the second clutch K2, in the eighth forward gear G8 the gear stages i_6, ZW_8, and i_7 are used, wherein the two subtransmissions are coupled to one another by the activated shift element N.

It is also apparent from the shift pattern according to FIG. 10 that, starting from the second clutch K2, in the reverse gear R1 the gear stage i_R is used. Furthermore, starting from the first clutch K1, in the further reverse gear R2 the gear stages i_3, i_4, and i_R are used, wherein the shift element M is engaged in order to couple the two subtransmissions. Starting from the first clutch K1, in the additional reverse gear R3 the gear stages ZW_8, i_6, and i_R are used, wherein the shift element N is engaged in order to couple the two subtransmissions.

Starting from the second clutch K2, in the overdrive gear O1 the gear stages i_4, i_3, and i_7 are used, wherein the two subtransmissions are coupled by the activated shift element M.

From the shift pattern of the 6th variant embodiment according to FIGS. 11 and 12, it is apparent in detail that, starting from the first clutch K1, in the first forward gear G1 the gear stages ZW_1, i_6, and i_2 are used, wherein the two subtransmissions are coupled to one another by the activated shift element N. In the second forward gear G2 the gear stage i_2, in the third forward gear G3 the gear stage i_3, in the fourth forward gear G4 the gear stage i_4, in the fifth forward gear G5 the gear stage i_5, in the sixth forward gear G6 the gear stage i_6, in the seventh forward gear G7 the gear stage i_7, and in the eighth forward gear G8 the gear stage i_8 are used.

From the shift pattern according to FIG. 12, it is apparent that, starting from the first clutch K1, in the reverse gear R1 the gear stages i_7, i_R, and i_2 are used, wherein the shift element M is activated in order to couple the two subtransmissions.

In summary, it is apparent from the 1st variant embodiment according to FIGS. 1 and 2 that the eighth forward gear is implemented as a winding path gear by way of the gear stages of the sixth, fifth, and seventh gears. Furthermore, four dual gear planes are provided, by which a reverse gear R1 which can be power shifted relative to the second gear is implemented, thereby enabling the vehicle to be “rocked free”. Furthermore, an additional crawler gear that is power shiftable relative to the second gear can be implemented to achieve better handling in the terrain.

Specifically, for the 1st variant embodiment, with the first gear plane 8-12 as a dual gear plane, the idler gear 8 is used for three forward gears G2, C1, C3 and for two reverse gears R1, R2, and the idler gear 12 is used for four forward gears G4, C2, C4, O2. With the second gear plane 9-13 as a dual gear plane, the idler gear 9 is used for six forward gears G6, G8, C3, C4, O1, O2 and for one reverse gear R3, and the idler gear 13 is used for three reverse gears R1 to R3. With the third gear plane 10-14 as a dual gear plane, the idler gear 10 is used for four forward gears G5, G8, C1, C3, and the idler gear 14 is used for five forward gears G7, G8, C2, O1, O2 and for one reverse gear R1. With the fourth gear plane 11-15 as a dual gear plane, the idler gear 11 is used for four forward gears G1, C2, C4, O1, and the idler gear 15 is used for two forward gears G3, C1 and for two reverse gears R2, R3.

In summary, it is apparent from the 2nd, 3rd, and 4th variant embodiments according to FIGS. 3 and 8 that the eighth forward gear is implemented as a winding path gear by way of the gear stages of the second, first, and seventh gears. Furthermore, a reverse gear R1 that is power shiftable relative to the first forward gear is provided, thereby enabling the vehicle to be rocked free.

In the second variant embodiment, four dual gear planes are provided, thereby implementing a very compact power shiftable eight-speed transmission.

Specifically, for the 2nd variant embodiment, with the first gear plane 8-12 as a dual gear plane, the idler gear 8 is used for two forward gears G4, O1 and for one reverse gear R5, and the idler gear 12 is used for five forward gears G6, C2, C3, O2, O3. With the second gear plane 9-13 as a dual gear plane, the idler gear 9 is used for five forward gears G2, G8, C1, C3, O3 and for one reverse gear R4, and the idler gear 13 is used for five reverse gears R1 to R5. With the third gear plane 10-14 as a dual gear plane, the idler gear 10 is used for four forward gears G1, G8, C2, O1 and for three reverse gears R1, R2, R5, and the idler gear 14 is used for four forward gears G3, C1, C3, O2 and for two reverse gears R1, R4. With the fourth gear plane 11-15 as a dual gear plane, the idler gear 11 is used for four forward gears G5, C1, O2, O3 and for one reverse gear R3, and the idler gear 15 is used for four forward gears G7, G8, C2, O1 and for two reverse gears R2, R3.

In the 3rd variant embodiment according to FIGS. 5 and 6, three dual gear planes and two single gear planes are provided. By dividing the gear stages of the fifth and seventh gears to two single gear planes, the stepping can be better adjusted.

Specifically, for the third variant embodiment, with the first gear plane 8-12 as a dual gear plane, the idler gear 8 is used for three forward gears G4, C3, O1 and for one reverse gear R4, and the idler gear 12 is used for six forward gears G6, C2, C3, C4, O2, O3. In the second gear plane 9-13, the idler gear 9 is used for five forward gears G2, G8, C1, C4, O3 and for one reverse gear R3, and the idler gear 13 is used for four reverse gears R1 to R4. With the third gear plane 10-14 as a dual gear plane, the idler gear 10 is used for four forward gears G1, G8, C2, O1 and for three reverse gears R1, R2, R4, and the idler gear 14 is used for five forward gears G3, C1, C3, C4, O2 and for two reverse gears R1, R3. With the fourth gear plane 11-4 as a single gear plane, the idler gear 11 is used for four forward gears G5, C1, O2, O3. With the fifth gear plane 5-15 as a single gear plane, the idler gear 15 is used for four forward gears G7, G8, C2, O1 and for one reverse gear R2.

In the 4th variant embodiment, three dual gear planes and two single gear planes are provided. By providing the gear stage of the seventh gear on the first countershaft and the gear stage of the fifth gear on the second countershaft, this wheel set offers improved adjustability of the stepping.

Specifically, for the 4th variant embodiment, with the first gear plane 8-12 as a dual gear plane, the idler gear 8 is used for five forward gears G4, C1, C4, O1, O4 and for one reverse gear R4, and the idler gear 12 is used for eight forward gears G6, C4, C5, C6, O2, O3, O4, O5. With the second gear plane 9-13 as a dual gear plane, the idler gear 9 is used for seven forward gears G2, G8, C2, C3, C5, C6, O5 and for one reverse gear R3, and the idler gear 13 is used for four reverse gears R1 to R4. With the third gear plane 10-14 as a dual gear plane, the idler gear 10 is used for three forward gears G1, G8, O1 and for three reverse gears R1, R2, R4, and the idler gear 14 is used for six forward gears G3, C1, C2, C4, C5, O2 and for two reverse gears R1, R3. With the fourth gear plane 11-4 as a single gear plane, the idler gear 11 is used for nine forward gears G7, G8, C1, C2, C3, O2, O3, O4, O5. With the fifth gear plane 5-15 as a single gear plane, the idler gear 15 is used for five forward gears G5, C3, C6, O1, O3 and for one reverse gear R2.

In the 5th variant embodiment according to FIGS. 9 and 10, the first forward gear and the eighth forward gear are implemented as winding path gears. Four dual gear planes are provided. Furthermore, an overdrive gear that is power shiftable relative to the seventh forward gear can be implemented to achieve fuel consumption savings.

Specifically, for the 5th variant embodiment, with the first gear plane 8-14 as a dual gear plane, the idler gear 8 is used for two forward gears G1, G2, and the idler gear 14 is used for three reverse gears R1 to R3. With the second gear plane 9-15 as a dual gear plane, the idler gear 9 is used for three forward gears G1, G4, O1 and for one reverse gear R2, and the idler gear 15 is used for two forward gears G6, G8 and for one reverse gear R3. In the third gear plane 10-16, the idler gear 10 is used for three forward gears G1, G3, O1 and for one reverse gear R2, and the idler gear 16 is used for one forward gear G8 and for one reverse gear R3. With the fourth gear plane 11-17 as a dual gear plane, the idler gear 11 is used for one forward gear G5, and the idler gear 17 is used for three forward gears G7, G8, O1.

In the 6th variant embodiment according to FIGS. 11 and 12, the first gear can be implemented as a winding path gear by way of the gear stages of the sixth and second gears and by way of the additional gear stage ZW_1, which is not used in any other forward gear. Furthermore, four dual gear planes and a single gear plane are provided. In addition, a reverse gear that is power shiftable relative to the second forward gear can be implemented, thereby enabling the vehicle to be “rocked free”.

Specifically, it is apparent from the shift pattern according to FIG. 12 that, with the first gear plane 7-13 as a dual gear plane, the idler gear 7 is used for one forward gear G4, and the idler gear 13 is used for two forward gears G1, G2 and for one reverse gear R1. With the second gear plane 8-2 as a single gear plane, the idler gear 8 is used for one forward gear G8. With the third gear plane 9-15 as a dual gear plane, the idler gear 9 is used for one reverse gear R1, and the idler gear 15 is used for two forward gears G1, G6. In the fourth gear plane 10-16, the idler gear 10 is used for one forward gear G7 and for one reverse gear R1, and the idler gear 16 is used for one forward gear G1. In the fifth gear plane 11-17, the idler gear 11 is used for one forward gear G5, and the idler gear 17 is used for one forward gear G3.

It is possible to use at least one additional gear stage ZW-x, such as ZW_8 or ZW_1, for winding path gears which are not used in a direct forward gear in one, or also in several of the variant embodiments. The use of an additional gear stage is apparent from the respective figures of the variant embodiments.

It is also possible to use gear wheels x1, x2, . . . x7, x8 for additional winding path gears, which can be added to a single gear plane, whereby the sequential numbering of the gear wheels x1, x2, . . . x7, x8 is performed as follows. The sequential numbering begins with the first gear wheel x1 of the first countershaft w_v1, starting from the associated output stage i_ab_1, continuously up to the fourth gear wheel x4, wherein the first gear wheel on the second countershaft w_v2, starting from the associated output stage i_ab_2, is labeled x5 and the remaining gear wheels are numbered continuously up to x8. If the additional gear wheel x1, x2, . . . x7, x8 is used within the scope of a reverse gear transmission ratio, a rotation reversal takes place, such as by the use of an intermediate gear ZR on an intermediate shaft w_zw or the like.

Due to these intended multiple uses of individual idler gears, in all variant embodiments of the double clutch transmission fewer gear planes and therefore fewer components are required, thereby bringing about advantageous construction space and cost savings.

Independent of the respective variant embodiment, the number “1” in a field of the respective table of the shift patterns according to FIGS. 2, 4, 6, 8, 10 and 12 means that the associated clutch K1, K2, or the associated coupling device A, B, C, D, E, F, G, H, I, K, or the associated shift element M, N, P are engaged or activated. In contrast, an empty field in the respective table of the shift patterns according to FIGS. 2, 4, 6, 8, 10 and 12 means that the associated clutch K1, K2, or the associated coupling device A, B, C, D, E, F, G, H, I, K, or the associated shift element M, N, P are disengaged.

Deviating from the rules mentioned above, for a coupling device S_ab1 or S_ab2 associated with an output gear 20 or 21 it applies that if a field is empty in the respective table of the shift patterns according to FIGS. 2, 4, 6, 8, 10 and 12, the coupling device S_ab1 or S_ab2 must be disengaged, and that in the case of a field with number “1” in the respective table of the shift patterns according to FIGS. 2, 4, 6, 8, 10 and 12 the coupling device S_ab1 or S_ab2 should be engaged. Depending on the gear, the coupling device S_ab1 or S_ab2 must also be engaged for a group of gears for a field bearing the number “1”, while the coupling device S_ab1 or S_ab2 can both be disengaged or engaged for another group of gears for a field bearing the number “1”.

Furthermore, in many cases there is the possibility to engage additional coupling or shift elements, without influencing the flow of power. In this way, a gear preselection may be enabled.

### REFERENCE NUMERALS

1 Fixed gear of the second transmission input shaft
2 Fixed gear of the second transmission input shaft
3 Fixed gear of the first or second transmission input shaft
4 Fixed gear of the first transmission input shaft
5 Fixed gear of the first transmission input shaft
7 Idler gear of the first countershaft
8 Idler gear of the first countershaft
9 Idler gear of the first countershaft
10 Idler gear of the first countershaft
11 Idler gear of the first countershaft
12 Idler gear of the second countershaft
13 Idler gear of the second countershaft
14 Idler gear of the second countershaft
15 Idler gear of the second countershaft
16 Idler gear of the second countershaft
17 Idler gear of the second countershaft
19 Fixed gear of the output shaft
20 Output gear of the first countershaft
21 Output gear of the second countershaft
22 Torsion vibration damper
K1 First clutch
K2 Second clutch
w_an Drive shaft
w_ab Output shaft
w_v1 First countershaft
w_v2 Second countershaft
w_k1 First transmission input shaft
w_k2 Second transmission input shaft
A Coupling device
B Coupling device
C Coupling device
D Coupling device
E Coupling device
F Coupling device
G Coupling device
H Coupling device
Coupling device
K Coupling device
Gear stage first forward gear
i_2 Gear stage second forward gear
i_3 Gear stage third forward gear
i_4 Gear stage fourth forward gear
i_5 Gear stage fifth forward gear
i_6 Gear stage sixth forward gear
i_7 Gear stage seventh forward gear
i_8 Gear stage eighth forward gear
i_R Gear stage reverse gear
ZW_1 Additional gear stage for winding path gears
ZW_8 Additional gear stage for winding path gears
i_ab_1 Output stage on the first countershaft
i_ab_2 Output stage on the second countershaft
G1 First forward gear
G2 Second forward gear
G3 Third forward gear
G4 Fourth forward gear
G5 Fifth forward gear
G6 Sixth forward gear
G7 Seventh forward gear
G8 Eighth forward gear
C1 Crawler gear
C2 Crawler gear
C3 Crawler gear
C4 Crawler gear
C5 Crawler gear
C6 Crawler gear
O1 Overdrive gear
O2 Overdrive gear
O3 Overdrive gear
O4 Overdrive gear
O5 Overdrive gear
R1 Reverse gear
R2 Reverse gear
R3 Reverse gear
R4 Reverse gear
R5 Reverse gear
w_zw Intermediate shaft
ZR Intermediate gear for rotation reversal
ZS Gear stage used
M Shift element
N Shift element
P Shift element
S_ab1 Coupling device on the output stage, optional
S_ab2 Coupling device on the output stage, optional
psh. power shiftable

1-7. (canceled)

8. A double clutch transmission comprising:
first and second clutches (K1, K2) each comprising an input side connected to a drive shaft (w_an) and an output side connected to a respective one of a first and a second transmission input shaft (w_k1, w_k2) coaxially arranged with respect to one another;
at least first and second countershafts (w_v1, w_v2) supporting toothed idler gearwheels (7, 8, 9, 10, 11, 12, 13, 14, 15, 16, 17);
toothed fixed gearwheels (1, 2, 3, 4, 5) being supported on the first and the second transmission input shafts (w_k1, w_k2) in a rotationally fixed manner, the fixed gearwheels (1, 2, 3, 4, 5) engaging with at least one of the idler gearwheels (7, 8, 9, 10, 11, 12, 13, 14, 15, 16, 17);
a plurality of coupling devices (A, B, C, D, E, F, G, H, I, K) for connecting an idler gearwheel (7, 8, 9, 10, 11, 12, 13, 14, 15, 16, 17) to one of the first and the second countershafts (w_v1, w_v2) in a rotationally fixed manner;
omprising an output gear (20, 21) each on the two countershafts (w_v1, w_v2) which is coupled to a gearing of an output shaft (w_ab), and
at least one shift element (M, N, P) for connecting two toothed gearwheels in a rotationally fixed manner to one another so that at least several power shiftable forward gears (1, 2, 3, 4, 5, 6, 7, 8) and at least one reverse gear (R1, R2, R3, R4, R5) being shiftable;
wherein a maximum of five gear planes (7-13, 8-2, 8-12, 8-14, 9-13, 9-15, 10-14, 10-16, 11-4, 11-15, 11-17, 5-15) are provided, at least three of the maximum of five gear planes are dual gear planes (7-13, 8-12, 8-14, 9-13, 9-15, 10-14, 10-16, 11-15, 11-17), an idler gearwheel (7, 8, 9, 10, 11, 12, 13, 14, 15, 16, 17) of the first and the second countershafts (w_v1, w_v2) is associated with a fixed gear (1, 2, 3, 4, 5) of one of the first and the second transmission input shafts (w_k1, w_k2) for each of the dual gear planes (7-13, 8-12, 8-14, 9-13, 9-15, 10-14, 10-16, 11-15, 11-17), at least one idler gearwheel (7, 8, 9, 10, 11, 12, 13, 14, 15, 16, 17), in at least one of the double gear planes (7-13, 8-12, 8-14, 9-13, 9-15, 10-14, 10-16, 11-15, 11-17), is used for at least two gears so that at least one power shiftable winding path gear is shiftable by the at least one shift element (M, N, P).

9. The double clutch transmission according to claim 8, wherein the at least one shift element (M) is provided on the first countershaft (w_v1) and, upon activation of the at least one shift element (M) on the first countershaft (w_v1), an idler gearwheel (9) of a second subtransmission is connected to an idler gearwheel (10) of a first subtransmission so that at least one of a first forward gear (G1), an eighth forward gear (G8), and a reverse gear (R1) is shiftable as a winding path gear upon activation of the at least one shift element (M) on the first countershaft (w_v1).

10. The double clutch transmission according to claim 8, wherein the at least one shift element (N) is provided on the second countershaft (w_v2), an idler gear (15) of a second subtransmission is connected with an idler gear (16) of a first subtransmission upon activation of the at least one shift element (N) on the second countershaft (w_v2) so that at least one of a first forward gear (G1) and an eighth forward gear (G8) is shiftable as a winding path gear upon activation of the at least one shift element (N) on the second countershaft (w_v2).

11. The double clutch transmission according to claim 8, wherein the at least one shift element (P) is provided on the second countershaft (w_v2), an idler gear (13) of a second subtransmission is connected with an idler gear (14) of a first subtransmission by activation of the at least one shift element (P) is provided on the second countershaft (w_v2) so that at least one reverse gear (R1, R3, R4) is shiftable as a winding path gear upon activation of the at least one shift element (P) is provided on the second countershaft (w_v2).

12. The double clutch transmission according to claim 8, wherein the double clutch transmission has four dual gear planes, the fixed gearwheels (1, 2 or 2, 3) of the second transmission input shaft (w_k2) of a second subtransmission are associated with a first gear plane (8-12, 8-14) and a second gear plane (9-13, 9-15) which are each dual gear planes, and
the fixed gears (3, 4 or 4, 5) of the first transmission input shaft (w_k1) of a first subtransmission are associated with a third gear plane (10-14, 10-16) and a fourth gear plane (11-15, 11-17) which are each dual gear planes.

13. The double clutch transmission according to claim 8, wherein the double clutch transmission has three dual gear planes and two single gear planes, the fixed gearwheels (1, 2) of the second transmission input shaft (w_k2) of a second subtransmission are associated with a first gear plane (8-12) and a second gear plane (9-13) which are both dual gear planes, and
the fixed gears (3, 4, 5) of the first transmission input shaft (w_k1) of a first subtransmission are associated with a third gear plane (10-14), which is a dual gear plane, a fourth gear plane (11-4), which is a single gear plane, and a fifth gear plane (5-15), which is a single gear plane.

14. The double clutch transmission according to claim 8, wherein the double clutch transmission has four double gear planes and a single gear plane, the fixed gearwheels (1, 2, 3) of the second transmission input shaft (w_k2) of a second subtransmission are associated with a first gear plane (7-13), which is a dual gear plane, a second gear plane (8-2), which is a single gear plane, and a third gear plane (9-15), which is a dual gear plane, and
the fixed gears (4, 5) of the first transmission input shaft (w_k1) of a first subtransmission are associated with a fourth gear plane (10-16), which is a dual gear plane, and a fifth gear plane (11-17), which is a dual gear plane.
